(19) United States
(12) Patent Application Publication
(10) Pub. No.: US 2012/0302929 A1
(43) Pub. Date: Nov. 29, 2012

(54) Head mounted pulse action facial and head massager band

(76) Inventor: Vitaly Tkachenko, North Lauderdale, FL (US)

(21) Appl. No.: 13/114,011

(22) Filed: May 23, 2011

(51) Int. Cl. A61H 1/00

(52) U.S. Cl. 601/48

(57) ABSTRACT

A pulse action facial and head massager band apparatus including a headband assembly for mounting to a user's head. The headband is equipped with small vibrators that consist of small shaft less motors which quietly pulsate direct vibrations into the selected temple and jaw portion of the user's head and face.

### CROSS-REFERENCE TO RELATED APPLICATIONS

| | | | |
|---|---|---|---|
| Re. 31,603 | June 1984 | Christensen | 318/114 |
| 2,227,276 | December 1940 | Salit | 128/62 |
| 4,052,981 | October 1977 | Bachmann | 128/36 |
| 4,105,024 | August 1978 | Raffel | 128/33 |
| 4,129,808 | December 1978 | Bregeault et al. | 318/254 |
| 4,232,661 | November 1980 | Christensen | 128/33 |
| 4,286,162 | August 1981 | Suzuki | 250/439 P |
| 4,286,163 | August 1981 | Suzuki | 250/439 P |
| 4,286,199 | August 1981 | Nagakubo et al. | 318/327 |
| 4,458,183 | July 1984 | Neilson | 318/139 |
| 4,614,999 | September 1986 | Onodera et al. | 363/28 |
| 4,841,954 | June 1989 | Kalsi | 128/36 |
| 4,920,466 | April 1990 | Liu | 362/105 |
| 5,018,511 | May 1991 | Yokoi | 128/33 |
| 5,075,608 | December 1991 | Erdman et al. | 318/599 |
| 5,113,852 | May 1992 | Murtonen | 128/33 |
| 5,115,769 | May 1992 | Fiorini | 128/32 |
| 5,421,799 | June 1995 | Rabin et al. | 601/71 |
| 5,635,807 | June 1997 | Lautzenhiser | 318/625 |
| 5,767,634 | June 1998 | Taylor et al. | 318/34 |

### Current U.S. Class: 318/34; 318/114; 318/400.11; 318/400.13; 318/400.42; 601/70; 601/71

### Current International Class: A61H 23/02 (20060101); A61H 001/00 ( ); A61B 006/14 ( ); H02P 005/16 ( )

### Field of Search: 318/34-89,114,129,132,138,245,254,599 128/52,33,32,36,44 250/439P 601/70,71,79,48

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to electronically pulsating massage devices, and more particularly to head mounted pulsating facial massage devices.

### BACKGROUND OF THE INVENTION

Pulsating massage devices are commonly used to relieve muscular pain, to relieve stress, and to produce a generally pleasant sensation. Such devices are usually applied directly to the area being massaged, for example by holding the device against a user's neck and mounting the massaging unit on the user's head.

Prior electric head and facial massage units include a large electric shaft motor, a mechanical element coupled to the motor to communicate motor-produced vibrations to the user, and an electronic circuit that controls the motor. Also, prior art relies on vibrators/motors with a shaft and a small weight, which makes the devices larger, heavier, and noisy; and gives the user negative effects due to the prior design of mounting the vibrator in a specific way, directing its pulse/vibration to the entire head/face unit instead of a direct pulse to the selected muscle or facial area. This in turn lessens the effect of relaxing the muscle and may even make the experience unpleasant due to increased noise and useless/irritable vibrations pulsating in undesirable areas. Further, prior art design devices are more complicated to use, and appear strange and embarrassing to wear which confines one to indoor use only.

In summary, there is a need for a simple light weight pulse action head and face massage unit that quietly directs the pulsating vibrations directly into the selected portion of the face or head without disturbing or irritating other areas of the face or head.

Preferably such a massage unit should be lightweight, pulsating vibrations gently and quietly onto the desired area of the face and head by utilizing small shaft less motors/vibrators and must fit very comfortably on the user's head without being strapped. Such a massage unit should be easily operated by being activated automatically as it is placed on the user's head, rather than having the user locate the switch to then manually turn it on. The present invention provides such a massage unit.

### BRIEF SUMMARY OF THE INVENTION

The facial and head massager band is worn on the user's head and it massages multiple desired areas. The band is equipped with four small and light weight shaft less motors/vibrators that are used to induce relaxing pulses directly into the head and facial muscles with small shaft less motors/vibrators operating at low revolutions per minute (RPM) which are substantially less noisy during operation than prior art's larger vibrators/motors with shaft and weight attached. The facial and head massager is designed to be inconspicuous, stylish, and light, so that the user may continue with their daily tasks and enjoy being relaxed as a result of massaging pulses. The device is also designed to be activated automatically by being placed on the head, rather than having the user locate the switch to then manually turn it on.

The massaging band and the vibrators' housing are strategically designed to be easily adjusted to ensure a perfect fit for each user. The massager band provides direct contact with the temple portion of the forehead and temporal lobes stimulating the temporalis muscle, inducing pleasure along with relaxation, which in some cases may also help to reduce headaches. The band also provides direct contact with the jaw portion of the user's face stimulating the masseter muscle, which may help to reduce the Myofascial pain in patients that suffer from Temporomandibular Joint and Muscle Disorders (TMJDs).

### BRIEF DESCRIPTION OF THE SEVERAL VIEWS OF THE DRAWING

FIG. 1 is a front view of a massager mounted on users head thereof;

FIG. 2 is a rear view of a massager mounted on users head thereof;

FIG. 3 is a side view of a massager mounted horizontally on users head thereof;

FIG. 4 is a side view of a massager rotated vertically on users head thereof;

FIG. 5 is a perspective front view of a massager thereof; and,

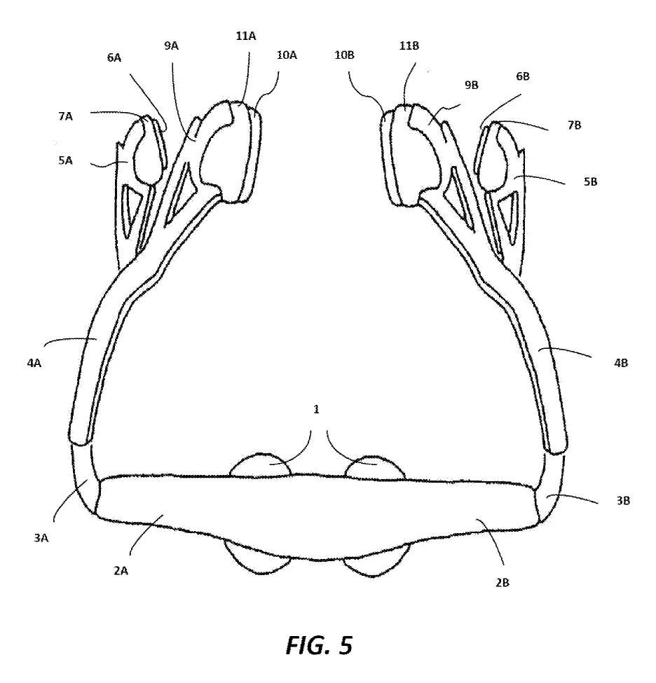

FIG. 6 is a perspective rear view of a massager.

FIG. 7 is a simple block diagram.

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

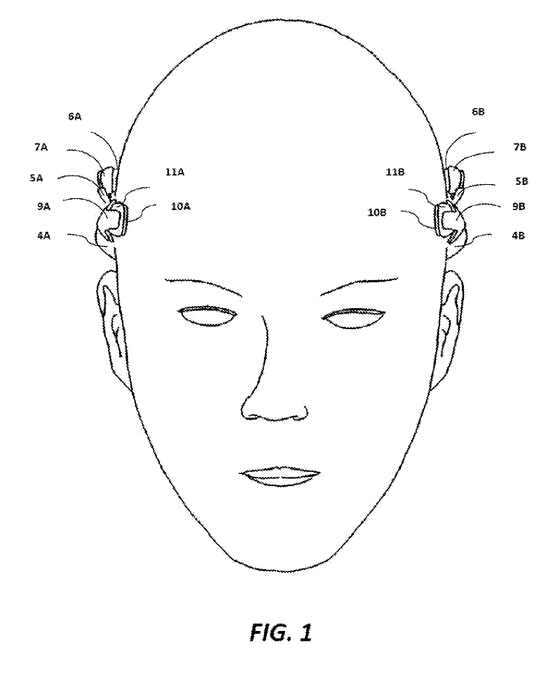

Attention is now directed to FIGS. 1 & 6 where a pulse action facial massager apparatus generally designated is illustrated including a headset assembly formed and dimensioned for mounting to a user's head. The components are numbered from 1 to 13.
PART 1: is the battery terminal housing that holds and recharges two rechargeable lithium ion batteries.
PART 2: is the flexible rear portion of the massager band.
PART 3: is the retractable portion of a massager band, made up of molded rubber-like plastic material, having essentially throughout the central portion thereof, bendable metal.
PART 4: is the flexible front half of the band that houses the retractable portion of a massager band which supports the vibrators housing with vibrator mounts that hold the vibrators and sensor switches.
PART 5: is the vibrator housing, made up of molded rubber-like plastic material that supports the vibrator mounts which support the back vibrators.
PART 6: is the back vibrator.
PART 7: is the vibrator mount that connects the back vibrator to the vibrator housing.
PART 8: is the sensor switch that activates the band when mounted on the user's head and face.
PART 9: is the vibrator housing, made up of molded rubber-like plastic material that supports the vibrator mounts which support the front vibrators.
PART 10: is the front vibrator.
PART 11: is the vibrator mount that connects the front vibrator to the vibrator housing.
PART 12: is the controller unit that is connected to the back of the headband.
PART 13: is the charging connector housed inside the controller unit.

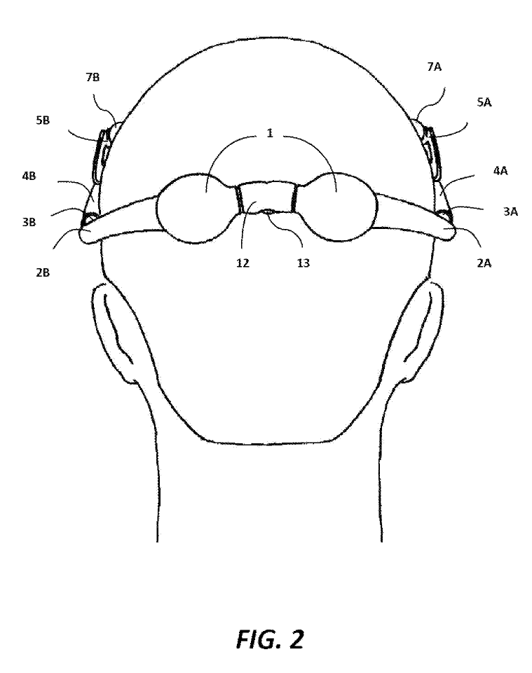

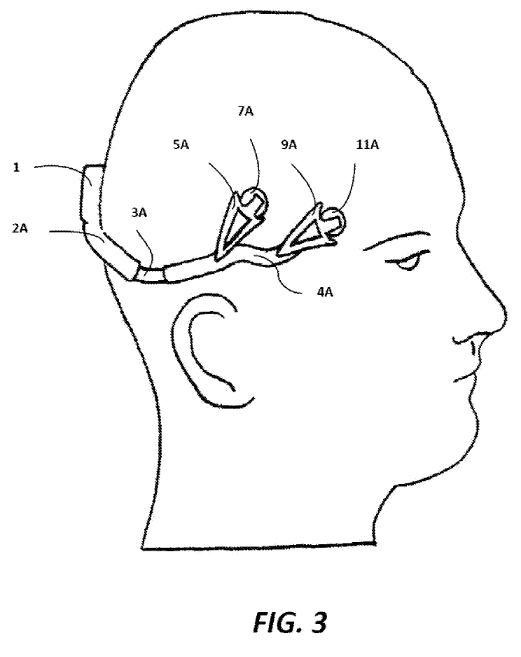

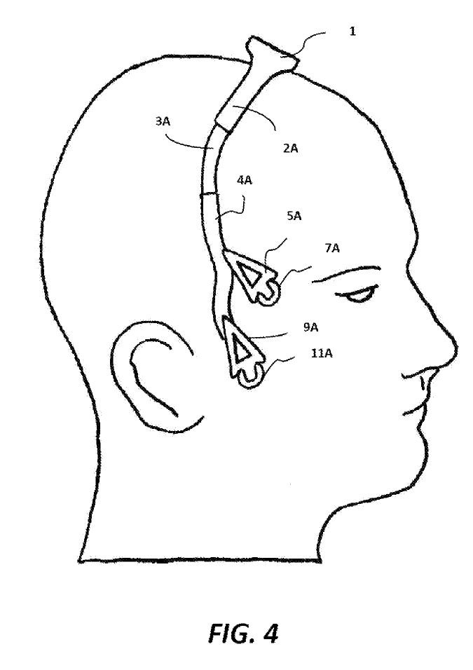

The facial and head massager band is worn on the user's head as shown in FIG. 1-4, and it massages multiple desired areas. The band is equipped with two small and light weight shaft less motors/vibrators 6A & 10A on the left side and two small and light weight shaft less motors/vibrators 6B & 10B on the right side, that are used to induce relaxing pulses directly into the muscle. The small shaft less vibrators 6A, 6B & 10A, 10B are designed to provide comfort by direct contact to the head as shown in FIGS. 1 & 3 and/or face as shown in FIG. 4 at low revolutions per minute (RPM) which are substantially less noisy during operation than prior art's larger vibrators/motors with shaft and weights attached. The facial and head massager is designed to be inconspicuous, stylish and light, so that the user may continue with their daily tasks and enjoy being relaxed as a result of the massaging pulses. The device is also designed to be activated automatically by being placed on the head, rather than having the user locate the switch to then manually turn it on.

Sections 4 of the band and the vibrators housing 5A, 5B & 9A, 9B are strategically designed to contain molded rubber-like plastic material, having essentially throughout a central portion thereof, bendable metal. The inner central portion of the band 4A, 4B contains high fatigue and bendable metal that is covered by the moldable material, and remains well below the surface of the moldable material. This interior bendable metal when bent to a desired configuration stays in that configuration until changed by the wearer of the massager band. The bendable metal has a high fatigue life. In addition, the band can be easily adjusted by extending the length of the inverted arcs 4A & 4B for larger face and head proportions, and retracting for smaller face and head proportions. This will ensure a perfect fit for each user due to differences in head and face shapes.

The massager band provides direct contact with the temple portion of the forehead as shown in FIG. 1 and temporal lobes stimulating the temporalis muscle, and inducing pleasure along with relaxation, which in some cases may also help to reduce headaches. The band also provides direct contact with the jaw portion of the user's face as shown in FIG. 4 stimulating the masseter muscle, which may help to reduce the Myofascial pain in patients that suffer from Temporomandibular Joint and Muscle Disorders (TMJDs).

Modifications and variations may be made to the disclosed embodiments without departing from the subject and spirit of the invention as defined by the following claims.

What is claimed is:

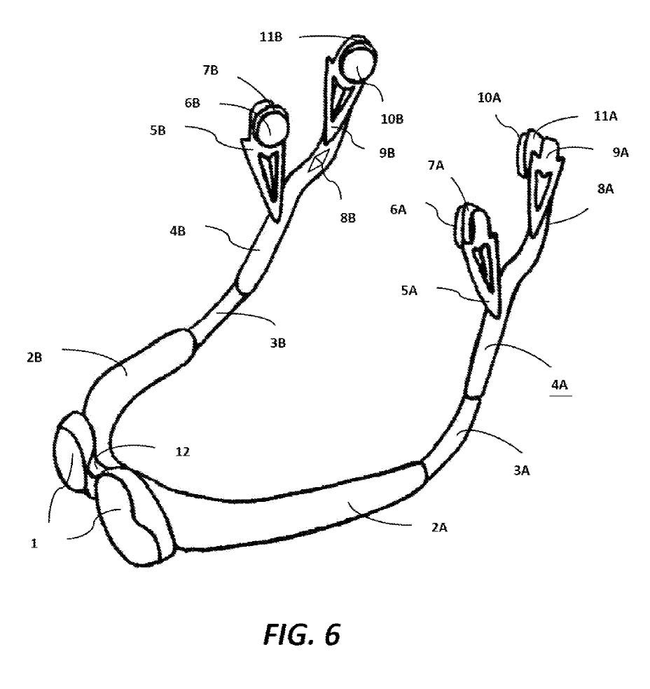

1. The U-shaped flexible band 2A & 2B extends upward on each side 3A & 3B with curved inverted arcs 4A & 4B as shown in FIG. 6 that are coupled with small shaft less vibrators 6A, 6B & 10A, 10B each generating an independent vibrating action.

2. The thin lightweight band is designed to be worn both horizontally and vertically with repositioning extensions 4A & 4B for selected contact of the user's head and face.
Hence, the horizontal position, as shown in FIGS. 1-3 provides direct contact with the temple portion of the forehead and temporal lobes stimulating the temporalis muscle. Alternatively, the vertical position, as shown in FIG. 4 provides direct contact with the jaw portion of user's face stimulating the masseter muscle.
The respective vibrating device as shown in FIG. 6 transmits the vibrating action thereof through the respective contact vibrators protruding from middle 6A & 6B and tip portion 10A & 10B of respective extension.

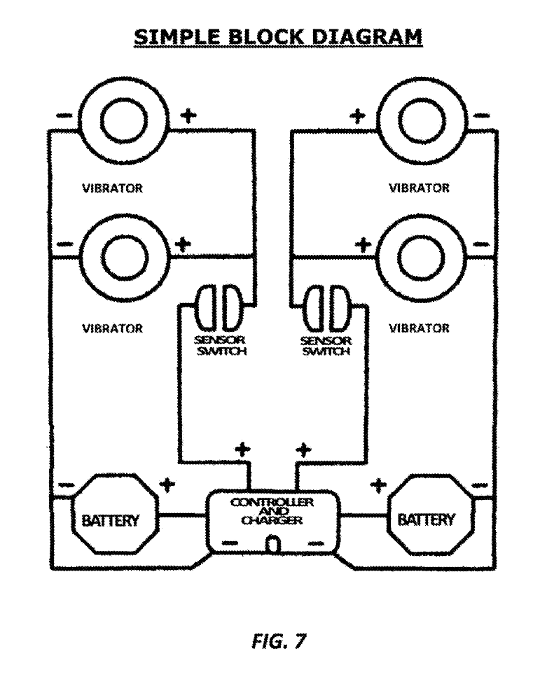

3. The band massager is equipped with sensor switches 8A & 8B located on the inner part of the inverted arcs 4A & 4B as shown in FIG. 6.
The sensor switches 8A & 8B activate the band automatically as shown in FIG. 7 when it is mounted on the head in either position, vertical or horizontal.
